(19) United States
(12) Patent Application Publication
(10) Pub. No.: US 2008/0069484 A1
(43) Pub. Date: Mar. 20, 2008

(54) POLYSTYRENE BAG WITH POLYETHYLENE ZIPPER

(76) Inventors: Thomas J. Jackman, Calgary (CA); Kirk A. Hardman, Calgary (CA); John K. Paegel, Calgary (CA); Jason P. Russo, Calgary (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, US

(21) Appl. No.: 11/858,344

(22) Filed: Sep. 20, 2007

Related U.S. Application Data
(60) Provisional application No. 60/826,278, filed on Sep. 20, 2006.

(51) Int. Cl. B65D 33/16; B23P 19/04

(52) U.S. Cl. 383/64; 29/700

(57) ABSTRACT

A polystyrene bag has a polyethylene zipper and the bag is constructed by choosing a polystyrene material having additives and a blended polyethylene material that is sufficiently compatible with the polystyrene material so that the zipper is weldable to the bag.

Applicant claims the benefit of U.S. Provisional Application Ser. No. 60/826,278 filed on Sep. 20, 2006.

### BACKGROUND OF THE INVENTION

1. Field of the Invention

This invention relates to a polystyrene bag with polyethylene zipper and to a method of constructing such a bag.

2. Description of the Prior Art

Thermoplastic bags with zippers are known. However, previous bags with zippers are not made from polystyrene material even though polystyrene material is superior in quality to polyethylene material in that the polystyrene has a clear, glossy appearance with better dart impact and tensile strength compared to polyethylene of the same thickness. Polyethylene bags can have a cloudier appearance and are not as glossy compared to polystyrene bags. Zippers have not been used with polystyrene bags as the zippers must be welded to the bag and polystyrene is not suitable for use as a zipper as polystyrene is not flexible enough in the thickness required for the zipper. Zippers are often made from polyethylene, but polyethylene is not weldable to polystyrene.

### SUMMARY OF THE INVENTION

It is an object of the present invention to provide a thermoplastic bag made of polystyrene with a weldable zipper made from a blended polyethylene. Any zipper that can be welded to the polystyrene will be suitable.

A thermoplastic bag comprises at least one longitudinal opening therein having a zipper. The at least one opening has two sides with zipper moieties being located along the two sides. The zipper moieties are sized and shaped to fit snugly together to close the at least one opening. The zipper moieties form the zipper. The bag, except for the zipper, is made from a polystyrene material and the zipper is made from a blended polyethylene material that is weldable to the polystyrene material.

A method of constructing a thermoplastic bag made from polystyrene material and having at least one opening therein. The at least one opening has a zipper thereon, the opening having two sides with zipper moieties being located along the two sides. The zipper moieties are sized and shaped to fit snugly together to close the at least one opening. The method comprises choosing a blended polyethylene material for the zipper that is weldable to the polystyrene material of the bag and welding the zipper to the bag.

### BRIEF DESCRIPTION OF THE DRAWINGS

In the drawings, FIG. 1 is a side view of a polystyrene bag having a blended polyethylene zipper;

FIG. 2 is a side view of a second embodiment of a polystyrene bag having a blended polyethylene zipper;

FIG. 3 is a third embodiment of a polystyrene bag having two zippers located thereon; and

FIG. 4 is a partial end view of the bag of FIG. 1 showing the zipper in a closed position.

### DESCRIPTION OF A PREFERRED EMBODIMENT

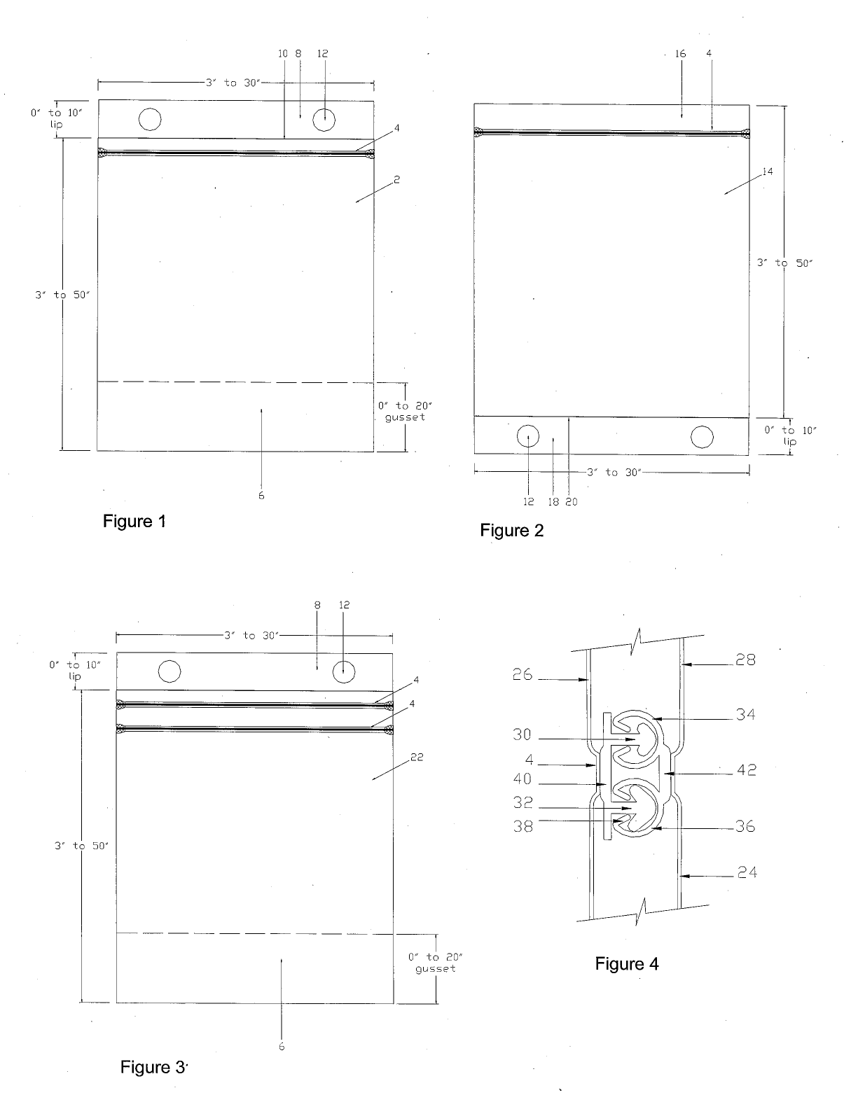

In FIG. 1, a thermoplastic bag 2 is made from a polystyrene material and a zipper 4 is made from a blended polyethylene material. The zipper 4 is welded to the bag 2. The polystyrene is a polystyrene resin that contains additives and the polyethylene is a blend of polyethylene that enables the zipper to be welded to the bag. Preferably, the polystyrene resin is a styrene-butadiene copolymer. Chevron Phillips product K-resin, DK13 (a trademark) is a suitable polystyrene. The blended polyethylene is a low density polyethylene with a metallocene sealing membrane. Preferably, the metallocene sealing member is co-extruded onto a blended polyethylene base layer. A suitable blended polyethylene zipper is manufactured by Presto Products (a trademark). The polystyrene film from which the bag is made provides a clear, glossy bag with good physical properties such as good tear strength and puncture resistance. The polystyrene material of the bag and polyethylene material of the zipper must be sufficiently compatible to enable the zipper to be welded to the bag. The bag 2 has a gusset 6 along a bottom portion thereof. The top of the bag 2 has a tearaway portion 8 located above the perforated line 10. The tearaway portion 8 has openings 12 therein. The openings can be used to hang several of the bags 2 from a holder (not shown). The zipper 4 is located beneath the tearaway portion 8. In FIG. 2, a bag 14 has a zipper 4 located near a top 16 with a retention portion located below a sealing line 20. The retaining portion 18 has openings 12 therein. The tearaway position 8 is a header.

In FIG. 3, the bag 22 is similar to the bag 2 shown in FIG. 1 except that the bag 22 has two zippers 4 located adjacent to one another. The same reference numerals are used in FIGS. 1 to 3 to describe those components that are identical.

In FIG. 4, there is shown a partial end view of the zipper 4 mounted in a bag 24 having a front side 26 and a rear side 28. The zipper 4 has two projections 30, 32 that are sized and shaped to removably fit within two receptacles 34, 36. The two projections 30, 32 are fixed to the front side 26 and the two receptacles 34, 36 are fixed to the rear side 28. The projection 32 is much larger than the projection 30 and fits snugly within the receptacle 36. The projection 30 fits more loosely in the receptacle 34. The receptacles 34, 36 each have a movable membrane 38 thereon that flexes to open when the projections 30, 32 are inserted into the receptacles 34, 36 and the zipper 4 is then in a closed position that is shown in FIG. 4. When the projections 30, 32 are located outside of the receptacles 34, 36, the zipper 4 is in an open position (not shown). The smaller projection 30 and receptacle 34 are easier to close and open than the larger projection 32 and the receptacle 36. The projections 30, 32 are mounted on a zipper moiety 40 on the front side 26 and the receptacles 34, 36 are mounted on a zipper moiety 42 on the rear side 28 on the bag 24. The zipper 4 is reopenable.

The zipper moieties can be designed to fit snugly or loosely together or the zipper moieties can be designed to permanently close the opening between the zipper moieties when the zipper moieties are closed. When the opening is permanently closed, the bag cannot be opened without noticeably damaging the bag by making a hole in one of the sides or by damaging or cutting the zipper moieties. Further, a zipper can have only one projection on one zipper moiety and one receptacle on the corresponding zipper moiety. A zipper can have more or fewer than two projections and receptacles. The zipper is not limited to the design shown in FIG. 4. Various sizes, shapes and types of zippers can be used.

As shown in FIGS. 1 to 3, polystyrene bags using polyethylene zippers as shown in the drawings can be of various designs. In addition to the designs shown in FIGS. 1 to 3, numerous other designs will also be suitable. For example, a polystyrene bag can have a zipper or zippers located along a lower portion of the bag and a zipper or zippers located along an upper portion of the bag. The zippers of a bag can be reopenable or they can be designed to be permanently closed as soon as they are closed for the first time.

The bag shown in FIG. 2 can have perforations located above the zipper to make the bag easier to open. A bag can have one zipper along a top of the bag and one zipper along a bottom of the bag. Reopenable zipper(s) can be used on the same bag as permanently closed zipper(s). The gussets shown are optional and can be used on any bag as desired. A zipper can extend completely across the bag or only partially along the bag. The shape of the bags can also vary.

We claim:

1. A thermoplastic bag comprising at least one longitudinal opening therein having a zipper, said at least one opening having two sides with zipper moieties being located along said two sides, said zipper moieties being sized and shaped to fit snugly together to close said at least one opening, said zipper moieties forming said zipper, said bag, except for said zipper, being made from a polystyrene material and said zipper being made from a blended polyethylene material that is weldable to said polystyrene material.

2. A thermoplastic bag as claimed in claim 1 wherein said polystyrene material is a polystyrene resin containing additives and said polyethylene material is a blended polyethylene material.

3. A thermoplastic bag as claimed in claim 2 wherein the blended polyethylene material is a low density polyethylene with a metallocene sealing membrane affixed to said polyethylene material.

4. A thermoplastic bag as claimed in claim 2 wherein the polystyrene material for the bag is a styrene-butadiene copolymer.

5. A thermoplastic bag as claimed in claim 2 wherein the blended polyethylene material comprises a metallocene layer co-extruded into a blended polyethylene back layer.

6. A thermoplastic bag as claimed in claim 2 wherein there are two zipper moieties, one zipper moiety being located along each side of said bag, one of said zipper moieties having a projection thereon, and the other of said zipper moieties having a receptacle thereon, said projection and receptacle extending longitudinally on the respective zipper moieties and corresponding to one another so that the projection is adapted to fit snugly within said receptacle.

7. A thermoplastic bag as claimed in claim 6 wherein said projection is a first projection and there is a second projection on said one zipper moiety above said first projection, said receptacle being a first receptacle, and there being a second receptacle on said other zipper moiety, said projections and said receptacles corresponding to one another, said second projection and said second receptacle being located above said first projection, and said second projection, said second projection being smaller than said first projection and being sized to fit loosely within said second receptacle.

8. A thermoplastic bag as claimed in claim 2 wherein said zipper moieties are shaped so that said zipper is reopenable after said zipper is closed.

9. A thermoplastic bag as claimed in claim 2 wherein said bag has a header located above said zipper, said header being removable from said bag.

10. A method of constructing a thermoplastic bag made from polystyrene material and having at least one opening therein, said at least one opening having a zipper thereon, said at least one opening having two sides with zipper moieties being located along said two sides, said zipper moieties being sized and shaped to fit snugly together to close said at least one opening, said method comprising choosing a blended polyethylene material for said zipper that is weldable to said polystyrene material of said bag and welding said zipper to the bag.

11. A method as claimed in claim 10 wherein said method comprises co-extruding a metallocene layer onto a blended polyethylene layer.

12. A method as claimed in claim 10 wherein said method comprises choosing a styrene-butadiene copolymer for the polystyrene material.

13. A method as claimed in claim 10 including the steps of locating two projections on one zipper moiety, and two receptacles corresponding to the two projections on another zipper moiety, sizing the projections relative to one another, so that an upper projection fits loosely within the corresponding receptacle when the zipper is closed, and the other projection fits snugly within the corresponding receptacle when the zipper is closed.
